(19) United States
(12) Patent Application Publication
(10) Pub. No.: US 2007/0028228 A1
(43) Pub. Date: Feb. 1, 2007

(54) Software upgrades with user advisement

(75) Inventors: Robert J. Battista, Rochester, MN (US); Bryan M. Logan, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/191,409

(22) Filed: Jul. 28, 2005

(51) Int. Cl. G06F 9/44

(52) U.S. Cl. 717/168

(57) ABSTRACT

Methods, apparatuses, and products are disclosed for software upgrades that include storing an upgrade on a computer, the upgrade having semantics for disparate configurations of computers; determining on the computer whether the upgrade can be effected concurrently; and, if the upgrade cannot be effected concurrently, advising a user of the upgrade's semantics on the computer.

### BACKGROUND OF THE INVENTION

1. Field of the Invention

The field of the invention is data processing, or, more specifically, methods, apparatuses, and products for software upgrades.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Maintaining these modern computer systems often requires periodic maintenance. The periodic maintenance often allows for greater utilization of the computer system.

One common example of periodic maintenance is the installation of software upgrades. The installation of software upgrades, however, sometimes requires rebooting the computer system or initial program load (‘IPL’ ). IPL is the loading of an operating system into a mainframe computer's main memory.

Some software upgrades may be effected concurrently. Such software upgrades may be installed, applied and activated without requiring an IPL. Software upgrades that can be effected concurrently therefore require little or no system downtime.

Other software upgrades, however, require system shutdown to give effect to the upgrade. These upgrades can be grouped into two categories, immediate and deferred. Immediate upgrades are critical to the system and should be effected immediately upon the installation of the upgrade. Examples of immediate upgrades include upgrades that affect data integrity and system stability. Deferred upgrades are upgrades that are not critical to the system and do not have to be effected immediately upon the installation of the upgrade. Examples of deferred upgrades often include upgrades that are hardware specific and are less critical than immediate fixes.

A system administrator can reduce system downtime by scheduling an IPL to effect deferred upgrades that are not critical to the administrator's system, thereby delaying the application and installation of deferred upgrades and waiting until several deferred software upgrades can effected concurrently. By scheduling an IPL when at least one critical upgrade is required the deferred upgrades do not create additional downtime for the system.

To schedule such an IPL, the system administrator must identify which upgrades are critical, which are deferred, and which are not relevant to the system at all. The method of delivery of upgrades compounds the problem of identifying their nature. Several upgrades are often packaged together in a service fix pack. One solution for the problem of identifying the nature of the upgrade is for the producer of an upgrade or upgrade package to include text which describes the application of the upgrade.

The text, however, can be confusing or a system administrator may lack the information for a fully-informed decision.

### SUMMARY OF THE INVENTION

Methods, apparatuses, and products are disclosed for software upgrades that include storing an upgrade on a computer, the upgrade having semantics for disparate configurations of computers; determining on the computer whether the upgrade can be effected concurrently; and, if the upgrade cannot be effected concurrently, advising a user of the upgrade's semantics on the computer.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system useful in software upgrades according to embodiments of the present invention.

FIG. 2 sets forth a block diagram of automated computing machinery comprising an exemplary computer useful in software upgrades according to embodiments of the present invention.

FIG. 3 sets forth a functional block diagram illustrating an exemplary system for software upgrades according to embodiments of the present invention.

FIG. 4 sets forth a flow chart illustrating an exemplary method for software upgrades according to embodiments of the present invention.

FIG. 5 sets forth a flow chart illustrating an additional exemplary method for software upgrades according to embodiments of the present invention.

FIG. 6 sets forth a flow chart illustrating an exemplary method for software upgrades that includes advising a user of the upgrade's semantics on the computer.

FIG. 7 sets forth a flow chart illustrating another exemplary method for software upgrades that includes advising a user of the upgrade's semantics on the computer.

### DETAILED DESCRIPTION OF EXEMPLARY EMBODIMENTS

### Detailed Description

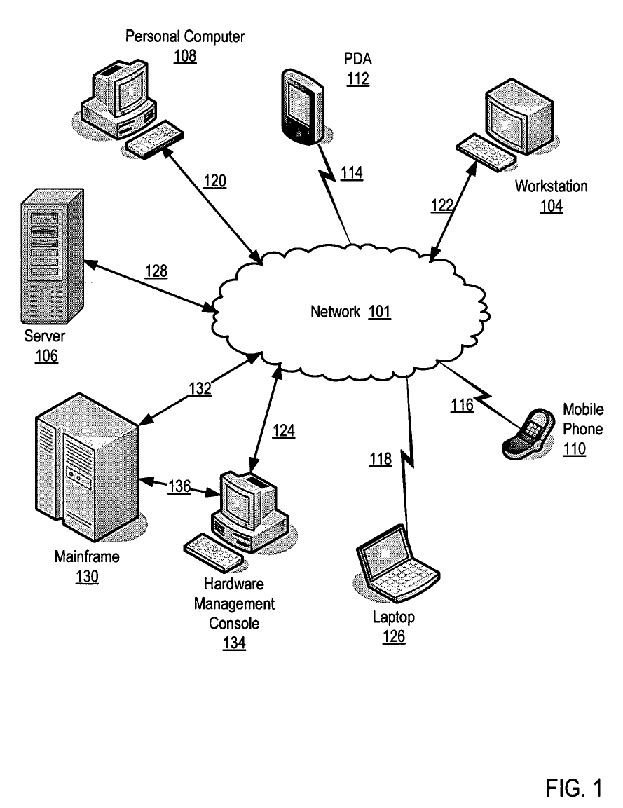

Exemplary methods, apparatuses, and products for software upgrades according to embodiments of the present invention are described with reference to the accompanying drawings, beginning with FIG. 1. FIG. 1 sets forth a network diagram illustrating an exemplary system useful in software upgrades according to embodiments of the present invention. The term ‘network’ is used in this specification to mean any networked coupling for data communications among two or more computers. Network data communication typically is implemented with specialized computers called routers. Networks typically implement data communications by encapsulating computer data in messages that are then routed from one computer to another. A well known example of a network is an ‘internet,’ an interconnected system of computers that communicate with one another according to the ‘Internet Protocol’ as described in the IETF's RFC 791. Other examples of networks useful with various embodiments of the present invention include intranets, extranets, local area networks (‘LANs’), wide area networks (“WANs”), and other network arrangements as will occur to those of skill in the art.

The system of FIG. 1 includes a data communications network (101). Network (101) provides data communications between computing devices or computers communicatively coupled to the network (101). Each of the computers communicatively coupled to the network (101) in FIG. 1 has installed upon it computer program instructions for applying and installing upgrades (‘installation function’) and is capable of receiving upgrades over the network and installing the upgrades as software, such as for example, firmware. ‘Firmware’ is software typically inserted into flash memory, programmable read-only memory (programmable ROM), or other memory functionally independent of main storage and which becomes a stable component of hardware. The software component of the firmware supports or enables the hardware component. Code in firmware, for example, enables servers, Ethernet PCI adapters and disk drives and many other hardware components as will occur to those of skill in the art.

An upgrade is a replacement for older software operating as software, such as a component of firmware. Upgrades typically update the software on a system. The upgrade may fix or improve the older software, may operate with new components of the system upon which or under which the older software ran, or may provide additional functionality.

Computers communicatively coupled to network (101) and capable of receiving upgrades over the network and installing the upgrades as software, such as for example, firmware in the system of FIG. 1 include:
workstation (104), a computer coupled to network (101) through wireline connection (122);
personal digital assistant (112), coupled to network (101) through wireless connection (114);
personal computer (108), coupled to network (101) through wireline connection (120);
server (106), coupled to network (101) through wireline connection (128);
mainframe (130), coupled to network (101) through wireline connection (132);
laptop computer (126), coupled to network (101) through wireless connection (118);
mobile phone (110), coupled to network (101) through wireless connection (116); and
hardware management console (134), coupled to network (101) though wireline connection (124) and coupled to mainframe (130) through wireline connection (136).

The hardware management console (134) of FIG. 1 has installed upon it computer program instructions which provide an interface and tools to manage other computers with complex system configurations. Among its other functions, the hardware management console (134) interface provides for downloading, installing, and managing software upgrades on itself and on the other computers, including upgrades that become a component of firmware.

The exemplary computers of FIG. 1 possess disparate configurations. The configuration of a system consists of its hardware and software components and the manner in which the components are organized and interconnected. The exemplary computers may run disparate operating systems, contain disparate types and numbers of processors and other hardware, and are organized and interconnected in disparate manners.

Each computer in FIG. 1 is improved for software upgrades in accordance with embodiments of the present invention. Each computer is capable of software upgrades by storing an upgrade, the upgrade having semantics for disparate configurations of computers; determining on the computer whether the upgrade can be effected concurrently; and, if the upgrade cannot be effected concurrently, advising a user of the upgrade's semantics on the computer.

The semantics of an upgrade describe the nature of the upgrade and its effect upon the computer. The semantics of an upgrade include whether the upgrade can be effected concurrently and if not, whether the upgrade is critical or deferred. Advising a user of the upgrade's semantics on the computer if the upgrade cannot be effected concurrently advantageously provides a system administrator with information useful in scheduling IPLs to give effect to upgrades that cannot be effected concurrently.

The arrangement of servers and other computers making up the exemplary system illustrated in FIG. 1 is for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

Various embodiments of the present invention may also be implemented on computers not connected by a network. Upgrades may be delivered to users of these computers not connected by a network by CDs, DVDs, and other removable media. In alternative embodiments of the invention, the hardware management console (134) may also be connected to mainframe (130) only through network (101) or the mainframe may download, install and manage software without the aid of a hardware management console.

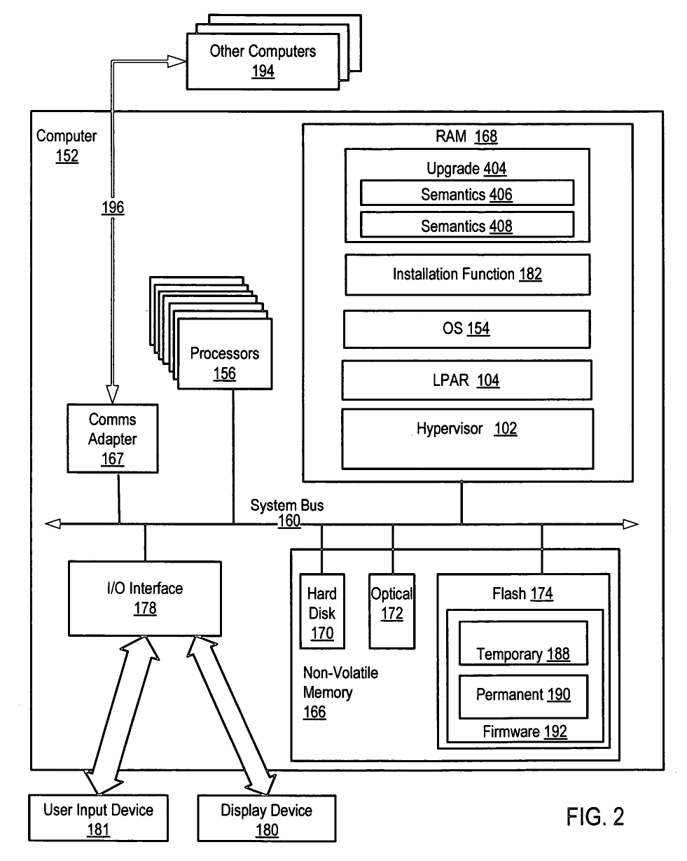

Software upgrades in accordance with the present invention are generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in software upgrades according to embodiments of the present invention. The computer (152) of FIG. 2 includes several processors (156) as well as random access memory (168) (‘RAM’) which is connected through a system bus (160) to the processors (156) and to other components of the computer.

Stored in RAM (168) is an upgrade (404). The upgrade (404) includes semantics (406 and 408) for disparate computer configurations. As described above, semantics (406 and 408) of an upgrade describe the nature of the upgrade and its effect upon a particular computer configuration. The semantics of an upgrade also include whether the upgrade can be effected concurrently and if not, whether the upgrade is critical or deferred.

The upgrade (404) in the example of FIG. 1 may be installed in permanent memory such as flash memory (174), to become a component of firmware, or it may be installed in hard disk (170) to upgrade an application program. As discussed above, firmware is software that is typically inserted into flash memory, programmable read-only memory (programmable ROM), or other memory functionally independent of main storage and which becomes a stable component of hardware. The software component of the firmware often supports or enables the hardware component.

Also stored RAM (168) in the example of FIG. 1 is an installation function (182). The exemplary installation function (182) comprises a set of computer program instructions improved for software upgrades according to embodiments of the present invention for storing an upgrade (404) on a computer (152), the upgrade (404) having semantics (406 and 408) for disparate configurations of computers; determining on the computer (152) whether the upgrade (404) can be effected concurrently; and if the upgrade cannot be effected concurrently, advising a user of the upgrade's semantics (406) on the computer (152). In the example of FIG. 2, the computer program instructions of the installation function can also determine whether an upgrade which cannot be installed concurrently with the continued execution of the computer is critical or is non-critical and may be deferred. Advising a user of the upgrade's semantics on the computer if the upgrade cannot be effected concurrently advantageously provides a system administrator with information useful in scheduling IPLs to give effect to upgrades that cannot be effected concurrently.

Also stored in RAM (168) is a logical partition (‘LPAR’) (104), a set of data structures and services that manages the distribution of computer resources within a single computer to enable the computer to function as if it were two or more independent computers. Each logical partition is assigned all the resources it needs to operate as though it were an independent computer, including processor time, memory, an operating system, and so on. Also stored RAM (168) is a hypervisor (102), a layer of system software that runs under operating systems in logical partitions to support the scheduling of time slices of the processors (156) on the logical partitions.

Also stored in RAM (168) is an operating system (154). Operating systems useful in computers according to embodiments of the present invention include UNIX™, Linux™, Microsoft Windows NT™, IBM AIX™, IBM i5/OS™, and others as will occur to those of skill in the art. Operating system (154), upgrade (404) with semantics (406 and 408), installation function (182), LPAR (104), and hypervisor (102) in the example of FIG. 2 are shown in RAM (168), but many components of such software typically are stored in non-volatile memory (166) also.

Computer (152) of FIG. 2 includes non-volatile computer memory (166) coupled through a system bus (160) to processors (156) and to other components of the computer (152). Non-volatile computer memory (166) may be implemented as a hard disk drive (170), optical disk drive (172), electrically erasable programmable read-only memory space (so-called ‘EEPROM’ or ‘flash’ memory) (174), RAM drives (not shown), or as any other kind of computer memory as will occur to those of skill in the art. In the example of FIG. 2, flash memory (174) stores firmware (192). The firmware (192) is divided into two sections, temporary (188) and permanent (190). The two sections may be used in processing upgrades to the firmware. As an example of the use of the sections, the temporary (188) section may hold the most recently upgraded firmware. The computer (152) can operate using this firmware by booting from the temporary (188) section. Upon the arrival of new upgrades, if the computer is operating successfully under the upgraded firmware, the contents of the temporary (188) section of the firmware may be written to the permanent (190) section of the firmware (192), and the new upgrade may be written to the temporary (188) section of the firmware (192). In case of a problem with an upgrade, the computer (152) can be restored to its pre-upgrade state by writing the contents of the permanent (190) section of the firmware (192) to the temporary (188) section of the firmware (192).

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (196) with other computers (194). Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

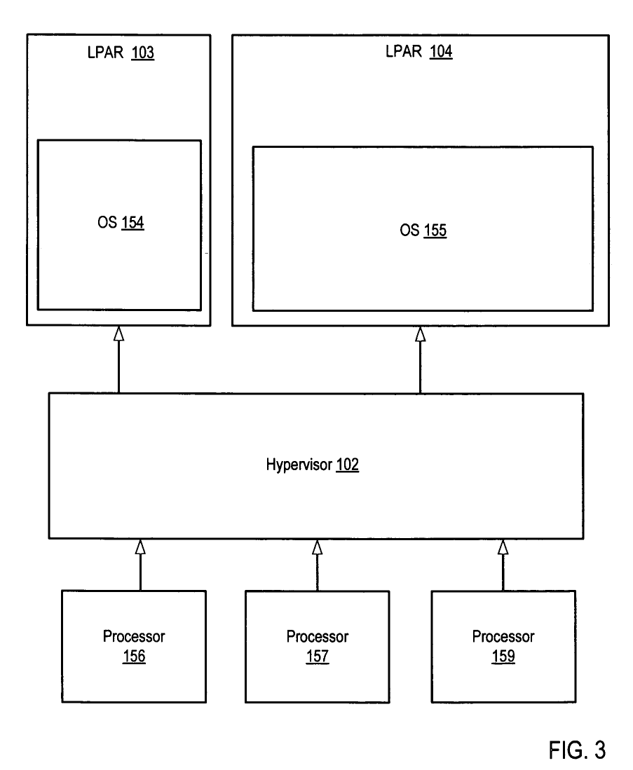

For further explanation, FIG. 3 sets forth a functional block diagram illustrating an exemplary system for software upgrades according to embodiments of the present invention. The system of FIG. 3 includes hypervisor (102), which schedules time slices in processors to LPARs. The system of FIG. 3 also includes LPAR (103) and LPAR (104), with each LPAR running a separate operating system, operating systems (154 and 155) respectively. The system of FIG. 3 also includes three processors (156, 157, and 159). In this example, the hypervisor schedules time slices in the processors (156, 157, and 159) on the LPARS (103 and 104).

The number and arrangement of LPARS and processors and the assignments of time slices in the processors to the LPARs in the system of FIG. 3 are for explanation only, and not for a limitation of the present invention. A system for software upgrades may include any number or arrangement of LPARS, operating systems, processors and hypervisors. A system for software upgrades may also consist of a single processor and a single operating system without a hypervisor or LPAR.

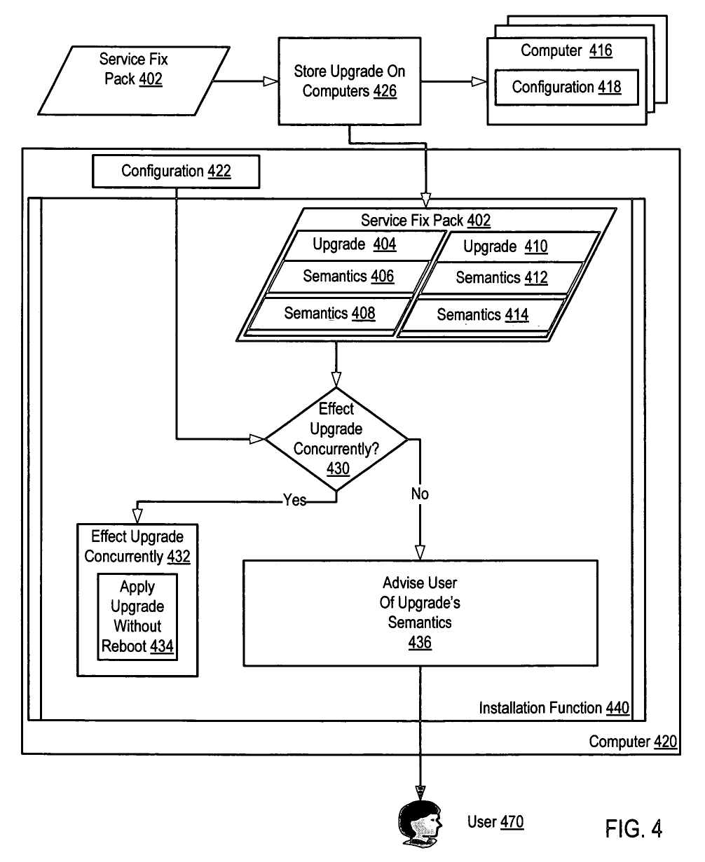

For further explanation, FIG. 4 sets forth a flow chart illustrating an exemplary method for software upgrades according to embodiments of the present invention that includes storing (426) an upgrade (404, 410) on a computer (416, 420), the upgrade having semantics (406, 408, 412, 414) for disparate configurations of computers. As discussed above, an upgrade is a replacement for older software operating as software, such as a component of firmware. Upgrades typically update the software on a system. The upgrade may fix or improve the older software, may operate with new components of the system upon which or under which the older software ran, or may provide additional functionality. In the method of claim 4, the upgrades include software upgrades and firmware upgrades. The upgrades may be applied to software, such as application programs or operating systems. The upgrades may also be stored in flash memory or other non-volatile computer memory and integrated with a hardware device to become a component of firmware.

Also as discussed above, a computer configuration is the hardware and software components of the computer and the manner in which they are organized and interconnected. The semantics of an upgrade for a particular computer system describes the nature of the software upgrade and the process for applying the software upgrade. The semantics of a software upgrade may specify whether the software upgrade can be effected or applied concurrently with the normal operation of the computer, or whether the normal operation of the computer must be halted to effect the upgrade. The semantics may also specify whether the software upgrade is critical and should be applied immediately, whether it is non-critical and the application can be deferred, or whether the software upgrade is unnecessary for the computer or configuration of the computer.

Storing (426) an upgrade (404, 410) on a computer (416, 420) according to the method of FIG. 4 may be carried out by installing a service fix pack (402) containing one or more upgrades for one or more computers having disparate configurations onto one or more computers. In the example of FIG. 4, the upgrade may saved in RAM or in flash memory or by other methods known to those of skill in the art. The upgrade may be supplied singularly or in a service fix pack as a compressed file, such as a zipped file, jar file, tar file, or any other form that will occur to those of skill in the art. In cases in which the upgrade is installed on the computer as a compressed file, storing the upgrade on a computer may also include restoring the file to its uncompressed state.

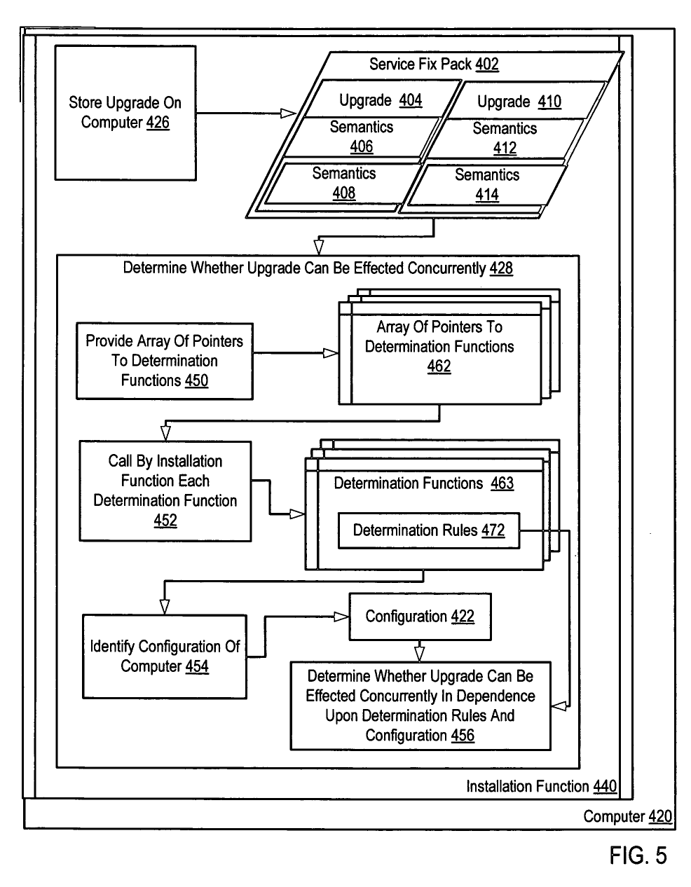

The method of FIG. 4 also includes determining (430) on the computer whether the upgrade can be effected concurrently. Determining (430) on a computer whether the upgrade can be effect concurrently may be carried out by providing an array of pointers to determination functions and calling by an installation function each determination function pointed to by each pointer as described in more detail below with reference to FIG. 5. A determination function for an upgrade is typically implemented as a program which in response to an identified configuration of the computer applies determination rules to determine whether an upgrade can be effected concurrently.

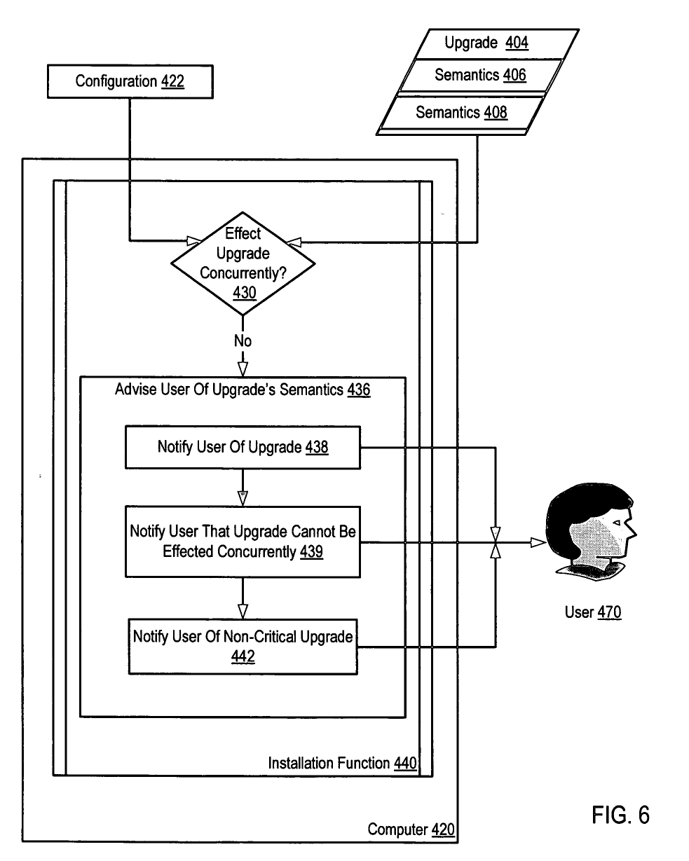

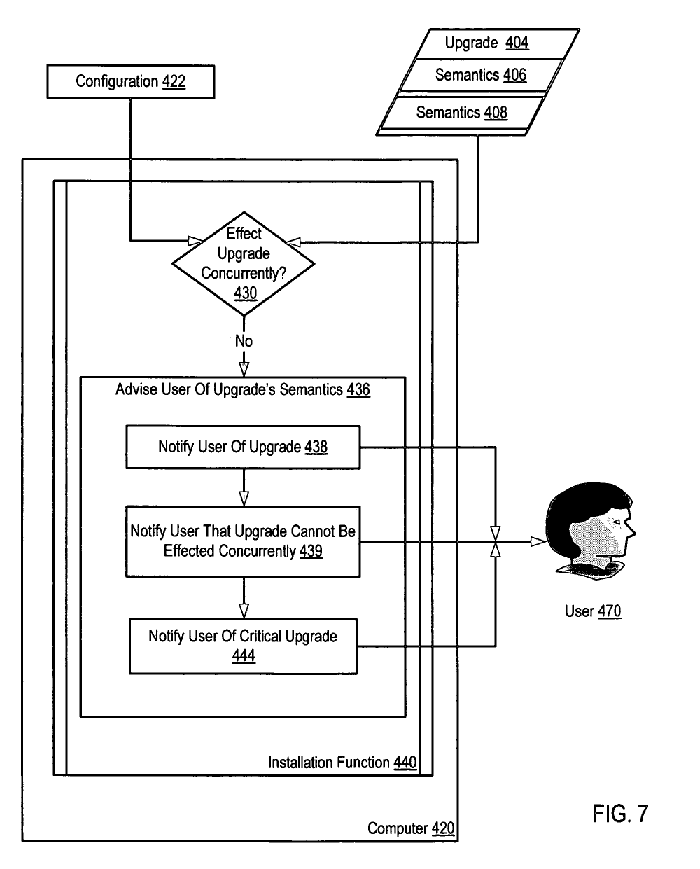

If the upgrade cannot be effected concurrently, the method of FIG. 4 also includes advising (436) a user (470) of the upgrade's semantics (406, 408, 412, and 414) on the computer (420). Advising (436) a user (470) of the upgrade's semantics (406, 408, 412, 414) on the computer (420) may be carried out by notifying the user of the upgrade, notifying the user that the upgrade cannot be effected concurrently, and notifying the user that the upgrade is not critical as discussed below with reference to FIG. 6. Advising (436) a user (470) of the upgrade's semantics (406, 408, 412, 414) on the computer (420) may also be carried out by notifying the user (470) of the upgrade, notifying the user that the upgrade cannot be effected concurrently, and notifying the user that the upgrade is critical as discussed below with reference to FIG. 7.

The method of FIG. 4 also includes effecting (432) an upgrade concurrently if the upgrade can be effected concurrently. Effecting an upgrade concurrently may be carried out by executing code implementing the upgrade while continuing other computer operations. The method of FIG. 4 also includes applying (434) the upgrade without reboot.

For further explanation, FIG. 5 sets forth a flow chart illustrating an exemplary method for software upgrades wherein determining (428) on a computer (420) whether the upgrade can be effected concurrently includes providing (450) an array of pointers (462) to determination functions (463). A determination function (463) for an upgrade is typically implemented as a program which in response to an identified configuration of the computer applies determination rules to determine whether an upgrade can be effected concurrently. The determination rules are rules which specify whether an upgrade can be effected concurrently for one or more configurations. Such rules may be dependent upon classes of software or hardware configurations, or even the presence of a single hardware or software component.

A pointer is a data structure that specifies the location of an object in memory such as data or an executable file. The simplest pointer is a word that contains the address of the object pointed to. An array of pointers is a data structure containing multiple pointers, each of which points to a determination function.

The method of FIG. 5 also includes calling (452) by an installation function (440) each determination function (463) pointed to by each pointer (462) and determining (428), by the determination function (463) whether the upgrade can be effected concurrently. In the method of FIG. 5, determining (428) on the computer whether the upgrade can be effected concurrently includes identifying (454) a configuration (422) of the computer. Identifying a configuration (422) of the computer according to the method of FIG. 5 can be carried out by querying an operating system of the computer and receiving in response to the query information describing the configuration of the computer. An engine for constructing and sending such a query may be built into the determination functions, may be built into the installation function, or may be made available to the determination function in any other way as will occur to those of skill in the art.

Identifying a configuration (422) of the computer according to the method of FIG. 5 can also be carried out by receiving information describing the configuration of the computer from a user. In such cases, a user may be empowered through a user interface to provide to the determination function information describing the configuration of the computer.

In the method of FIG. 5, determining (428) on the computer whether the upgrade can be effected concurrently further also includes determining (456) whether the upgrade can be effected concurrently in dependence upon the determination rules (472) and the configuration (422) of the computer (420). If the upgrade cannot be effected concurrently, the determination function may retrieve semantics describing the upgrade and advise a user of the upgrade's semantics on the computer. The semantics may prove useful to a system administrator in deciding whether to effect deferred upgrades.

In the method of FIG. 5, when several determination functions are contained in a single service fix pack with several upgrades, they may provide differing semantics for the upgrades. Thus, for example, one upgrade may be effected concurrently and another may be a deferred upgrade. In such a case, a system administrator may handle the upgrades differently depending upon the semantics for the upgrades provided by the determination functions.

An upgrade itself may include one or more a determination functions for software upgrades according to embodiments of the present invention. A developer's inclusion of the determination function with the upgrade enables the developer to tailor an upgrade specifically to particular configurations and reduces the reliance on a user's knowledge of the configuration of the computer. Such a determination function can be programmed to examine specific processor types, hardware versions, firmware versions of various types of firmware, LPAR configurations for computers with logical partitions, and other components of computers.

A user may also delete determination functions or the semantics they return after the application of the upgrades to which they related. Alternatively, the user may retain the determination functions for use in obtaining the semantics of the upgrade or the semantics themselves for use in determining whether to back up the level of system software or firmware. Such a determination function, may for example, be programmed to accept as input the previous configuration of the computer and provide in response the semantics of the upgrade for use in determining whether to back up the level of system software or firmware. Furthermore, a user may retain upgrades and determination functions and execute the determination functions upon changes to the configuration of the computer. Executing the determination functions with configuration changes advantageously provides a vehicle for determining whether upgrades that were previously unnecessary or deferred with the previous configuration are in fact critical under the new configuration.

For further explanation, FIG. 6 sets forth a flow chart illustrating an exemplary method for software upgrades that includes advising (436) a user (470) of the upgrade's semantics (406, 408) on the computer (420). In the method of FIG. 6, advising (436) a user (470) of the upgrade's semantics (406, 408) on the computer (420) includes notifying (438) the user (470) of an upgrade (404). Notifying (438) the user (470) of an upgrade (404) may be carried out by sending a message to the user (470) identifying the particular upgrade, playing an earcon or speech advisement of the particular upgrade to the user, or any other method of notifying (438) the user (470) of an upgrade (404) that will occur to those of skill in the art.

The method of FIG. 6 also includes notifying (439) the user that the upgrade cannot be effected concurrently. Notifying (439) the user that the upgrade cannot be effected concurrently may be carried out by sending the user a message informing the user that the upgrade cannot be effected concurrently, playing an earcon or speech advisement informing the user that the upgrade cannot be effected concurrently, or any other method of notifying (439) the user that the upgrade cannot be effected concurrently that will occur to those of skill in the art.

The method of FIG. 6 also includes notifying (442) the user that the upgrade is not critical. Notifying (442) the user that the upgrade is not critical may be carried out by sending the user a message informing the user that the upgrade is not critical, playing an earcon or speech advisement informing the user that the upgrade is not critical, or any other method of notifying (442) the user that the upgrade is not critical that will occur to those of skill in the art. Notifying (442) the user that the upgrade is not critical advantageously provides a user such as a system administrator with information useful in scheduling IPLs to give effect to upgrades that cannot be effected concurrently and that are not critical.

For further explanation, FIG. 7 sets forth a flow chart illustrating another exemplary method for software upgrades that includes advising (436) a user (470) of the upgrade's semantics (406, 408) on the computer (420). In the method of FIG. 7, advising (436) a user (470) of the upgrade's semantics (406, 408) on the computer (420) includes notifying (438) the user (470) of an upgrade (404). Notifying (438) the user (470) of an upgrade (404) may be carried out by sending a message to the user (470) identifying the particular upgrade, playing an earcon or speech advisement of the particular upgrade to the user, or any other method of notifying (438) the user (470) of an upgrade (404) that will occur to those of skill in the art.

The method of FIG. 7 also includes notifying (440) the user that the upgrade cannot be effected concurrently. Notifying (440) the user that the upgrade cannot be effected concurrently may be carried out by sending the user a message informing the user that the upgrade cannot be effected concurrently, playing an earcon or speech advisement informing the user that the upgrade cannot be effected concurrently, or any other method of notifying (439) the user that the upgrade cannot be effected concurrently that will occur to those of skill in the art.

The method of FIG. 7 also includes notifying (444) the user that the upgrade is critical. Notifying (442) the user that the upgrade is critical may be carried out by sending the user a message informing the user that the upgrade is critical, playing an earcon or speech advisement informing the user that the upgrade is critical, or any other method of notifying (444) the user that the upgrade is critical that will occur to those of skill in the art. Notifying (444) the user that the upgrade is critical advantageously provides a user such as a system administrator with information useful in determining whether to immediately initiate an IPL to give effect to the critical upgrade that cannot be effected concurrently.

The examples of FIGS. 6 and 7 included advising a user of the upgrade's semantics on the computer if an upgrade cannot be effected concurrently. In some embodiments of the present invention however, a determination function may also return additional semantics of an upgrade regardless of the whether the upgrade can be effected concurrently. Such semantics may describe that an upgrade is unnecessary for a particular configuration or ill-advised for a particular configuration. Such semantics may describe additional information such as maintenance information for the computer. Such semantics may also describe information unrelated, or only marginally related, to the upgrade or configuration such as advertising for the manufacturer of the upgrade.

It is apparent to readers of skill in the art in view of the preceding explanation that the advantages of practicing software upgrades according to embodiments of the present invention include reducing the downtime on computers necessary for installing upgrades by providing the users of the computers with information which enables them to install the upgrades efficiently, free from the burden of searching for detailed information about the configurations; and by enabling developers to tailor upgrades to specific configurations of computers.

Exemplary embodiments of the present invention are described largely in the context of a fully functional computer system for software upgrades. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as software or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for software upgrades, the method comprising:
storing an upgrade on a computer, the upgrade having semantics for disparate configurations of computers;
determining on the computer whether the upgrade can be effected concurrently; and
if the upgrade cannot be effected concurrently, advising a user of the upgrade's semantics on the computer.

2. The method of claim 1 wherein the upgrade comprises one of a plurality of upgrades contained in a service fix pack.

3. The method of claim 1 wherein the upgrade further comprises a firmware upgrade.

4. The method of claim 1 wherein determining on the computer whether the upgrade can be effected concurrently further comprises:
providing an array of pointers to determination functions; and
calling by an installation function each determination function pointed to by each pointer.

5. The method of claim 4 wherein each determination function includes determination rules and determining on the computer whether the upgrade can be effected concurrently further comprises:
identifying a configuration of the computer; and
determining whether the upgrade can be effected concurrently in dependence upon the determination rules and the configuration of the computer.

6. The method of claim 1 further comprising effecting the upgrade concurrently if the upgrade can be effected concurrently, including applying the upgrade without reboot.

7. The method of claim 1 wherein advising a user of the upgrade's semantics on the computer further comprises:
notifying the user of the upgrade;
notifying the user that the upgrade cannot be effected concurrently; and
notifying the user that the upgrade is not critical.

8. The method of claim 1 wherein advising a user of the upgrade's semantics on the computer further comprises:
notifying the user of the upgrade;
notifying the user that the upgrade cannot be effected concurrently; and
notifying the user that the upgrade is critical.

9. An apparatus for software upgrades, the apparatus comprising:
a computer processor;
a computer memory operatively coupled to the computer processor, the computer memory having disposed within it computer program instructions capable of:
storing an upgrade on a computer, the upgrade having semantics for disparate configurations of computers;
determining on the computer whether the upgrade can be effected concurrently; and
if the upgrade cannot be effected concurrently, advising a user of the upgrade's semantics on the computer.

10. The apparatus of claim 9 wherein the upgrade comprises one of a plurality of upgrades contained in a service fix pack.

11. The apparatus of claim 9 wherein the upgrade further comprises a firmware upgrade.

12. The apparatus of claim 9 wherein the computer memory also has disposed within it computer program instructions capable of:
providing an array of pointers to determination functions; and
calling by an installation function each determination function pointed to by each pointer.

13. The apparatus of claim 12 wherein each determination function includes determination rules and the computer memory also has disposed within it computer program instructions capable of:
identifying a configuration of the computer; and
determining whether the upgrade can be effected concurrently in dependence upon the determination rules and the configuration of the computer.

14. A computer program product for software upgrades, the computer program product disposed upon a signal bearing medium, the computer program product comprising:
computer program instructions for storing an upgrade on a computer, the upgrade having semantics for disparate configurations of computers;
computer program instructions for determining on the computer whether the upgrade can be effected concurrently; and
computer program instructions for advising a user of the upgrade's semantics on the computer if the upgrade cannot be effected concurrently.

15. The computer program product of claim 14 wherein the signal bearing medium comprises a recordable medium.

16. The computer program product of claim 14 wherein the signal bearing medium comprises a transmission medium.

17. The computer program product of claim 14 wherein the upgrade comprises one of a plurality of upgrades contained in a service fix pack.

18. The computer program product of claim 14 wherein the computer program instructions for determining on the computer whether the upgrade can be effected concurrently further comprise:
computer program instructions for providing an array of pointers to determination functions; and
computer program instructions for calling by an installation function each determination function pointed to by each pointer.

19. The computer program product of claim 18 wherein each determination function includes determination rules and the computer program instructions for determining on the computer whether the upgrade can be effected concurrently further comprise:
computer program instructions for identifying a configuration of the computer; and
computer program instructions for determining whether the upgrade can be effected concurrently in dependence upon the determination rules and the configuration of the computer.

20. The computer program product of claim 14 further comprising computer program instructions for effecting the upgrade concurrently if the upgrade can be effected concurrently, including computer program instructions for applying the upgrade without reboot.
